(19) United States
(12) Patent Application Publication
(10) Pub. No.: US 2020/0247327 A1
(43) Pub. Date: Aug. 6, 2020

(54) VEHICLE DISPLAY DEVICE

(71) Applicant: Toyota Jidosha Kabushiki Kaisha, Toyota-shi (JP)

(72) Inventor: Masaki Ito, Toyota-shi (JP)

(21) Appl. No.: 16/718,934

(22) Filed: Dec. 18, 2019

(30) Foreign Application Priority Data
Feb. 1, 2019 (JP) 2019-017039

(51) Int. Cl. B60R 11/00; G02B 27/01; B60K 35/00

(52) U.S. Cl. CPC B60R 11/00; G02B 27/0101; B60K 35/00; G02B 2027/0141; B60R 2300/205; B60K 2370/186; G02B 2027/014

(57) ABSTRACT

A vehicle display device is provided including a display section that is provided at a side window glass of a vehicle, that has light-transmitting properties, and that enables display of imagery over substantially the entire side window glass, a separate section that is provided at the display section at a position corresponding to a vehicle seat, and a switching section configured to switch between a display state and a non-display state of imagery on the separate section.

### CROSS-REFERENCE TO RELATED APPLICATION

This application is based on and claims priority under 35 USC 119 from Japanese Patent Application No. 2019-017039 filed on Feb. 1, 2019, the disclosure of which is incorporated by reference herein.

### BACKGROUND

### Technical Field

The present disclosure relates to a vehicle display device.

### Related Art

Japanese Patent Application Laid-Open (JP-A) No. 2017-090623 discloses a display section. This display section is configured including an image source that projects image light, and an optical sheet that is provided on side window glass of a vehicle and reflects part of the projected image light. This enables imagery to be displayed on the side window glass.

Depending on a travel state of the vehicle, it may be desirable to display the imagery over the entire side window glass in order to improve occupant comfort. Specifically, during autonomous driving, imagery might be displayed over the entire side window glass so that plural occupants of the vehicle, including a driver when the driver has been freed up from driving, can all enjoy the imagery. However, in cases in which it is necessary to check on the situation outside the vehicle while the imagery is being displayed, the field of view might be blocked by the displayed imagery. Although stopping display of the imagery in order to check on the situation outside the vehicle is conceivable, this might stop display of the imagery against the wishes of the other occupants who want to view the imagery, which could be detrimental to comfort. The related art leaves room for improvement in this respect.

### SUMMARY

In consideration of the above circumstances, the present disclosure provides a vehicle display device capable of providing a comfortable in-cabin space appropriate to the circumstances.

A vehicle display device according to a first aspect of the present disclosure includes a display section that is provided at a side window glass of a vehicle, that has light-transmitting properties, and that enables display of imagery over substantially the entire side window glass, a separate section that is provided to the display section at a position corresponding to a vehicle seat, and a switching section configured to switch between a display state and a non-display state of imagery on the separate section.

In the first aspect of the present disclosure, the display section of the vehicle display device is provided at the side window glass of the vehicle, and enables display of imagery over substantially the entire side window glass. The display section also has light-transmitting properties, such that the situation outside the vehicle can be checked from inside the cabin when imagery is not being displayed. The separate section is provided to the display section at a position corresponding to the vehicle seat, and the separate section can be switched between a display state and a non-display state of imagery using the switching section. Namely, an occupant sitting in the vehicle seat is able to easily check the situation outside the vehicle by setting the separate section to the imagery non-display state. Moreover, by switching between the display state and the non-display state of imagery at the separate section alone, the display state of imagery at locations other than the separate section can be maintained, such that of plural occupants, any occupants other than the occupant who wants to check the situation outside the vehicle are able to perceive the imagery at locations other than the separate section of the display section.

A vehicle display device according to a second aspect of the present disclosure is the first aspect, wherein the side window glass is provided with a fixed window frame formed by a divider bar extending substantially in a vehicle vertical direction and by a door frame demarcating the side window glass at an upper portion of a vehicle door, and the separate section is provided within the fixed window frame.

In the second aspect of the present disclosure, the fixed window frame with the separate section provided therein is configured by the divider bar and the door frame. Namely, a fixed window (referred to as a triangular window) configured by a fixed window frame is provided to a typical side window glass, and this fixed window configures the separate section. Accordingly, the separation between the separate section and other locations of the display section can be performed using an existing member.

A vehicle display device according to a third aspect of the present disclosure is the first aspect or the second aspect, wherein the switching section is configured to switch between the display state and the non-display state of imagery on the separate section in response to operation of an operation section by an occupant sitting in the vehicle seat corresponding to the separate section.

In the third aspect of the present disclosure, the switching section enables switching between displaying and not displaying imagery on the separate section in response to operation of the operation section. The operation section is operable by an occupant sitting in the vehicle seat corresponding to the separate section. Accordingly, the occupant is able to easily check the situation outside the vehicle or enjoy the imagery on the display section by operating the operation section.

The vehicle display device according to the first aspect of the present disclosure exhibits an effect of enabling a comfortable in-cabin space appropriate to the circumstances to be provided.

The vehicle display device according to the second aspect of the present disclosure exhibits an effect of enabling a reduction in costs.

The vehicle display device according to the third aspect of the present disclosure exhibits an of enabling a comfortable in-cabin space to be provided that better reflects the wishes of the occupant.

### BRIEF DESCRIPTION OF THE DRAWINGS

Exemplary embodiments of the present disclosure will be described in detail based on the following figures, wherein:

FIG. 1 is a block diagram illustrating a hardware configuration of a vehicle display device according to an exemplary embodiment;

FIG. 2 is a block diagram illustrating an example of functional configuration of a vehicle display device according to an exemplary embodiment;

FIG. 3 is a schematic side view illustrating a cabin interior of a vehicle including a vehicle display device according to an exemplary embodiment;

FIG. 4 is a schematic perspective view corresponding to FIG. 3, illustrating a state in which imagery is being displayed on a display section;

FIG. 5 is a schematic perspective view corresponding to FIG. 4, illustrating a state in which imagery is not displayed on a separate section; and

FIG. 6 is a flowchart illustrating a flow of operation of a vehicle display device according to an exemplary embodiment.

### DETAILED DESCRIPTION

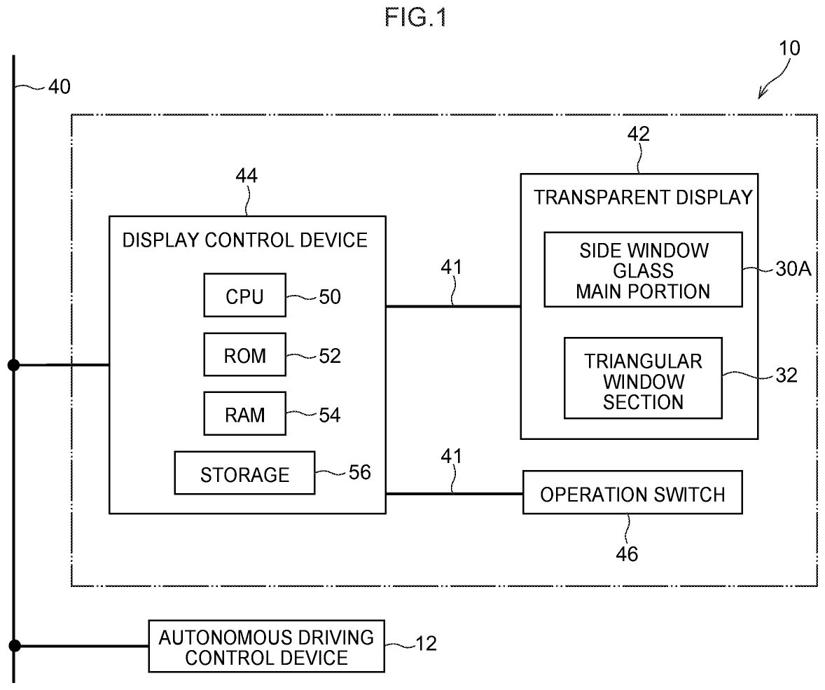

Explanation follows regarding a vehicle display device 10 of the present disclosure, with reference to FIG. 1 to FIG. 6. In the drawings, the arrow FR, the arrow UP, and the arrow OUT respectively indicate a forward direction (direction of travel), an upward direction, and a vehicle width direction outer side of a vehicle as appropriate. In the following explanation, reference simply to front and rear, left and right, and up and down directions refers to front and rear in a vehicle front-rear direction, left and right in a vehicle left-right direction (vehicle width direction), and up and down in a vehicle vertical direction, unless specifically stated otherwise.

Overall Configuration

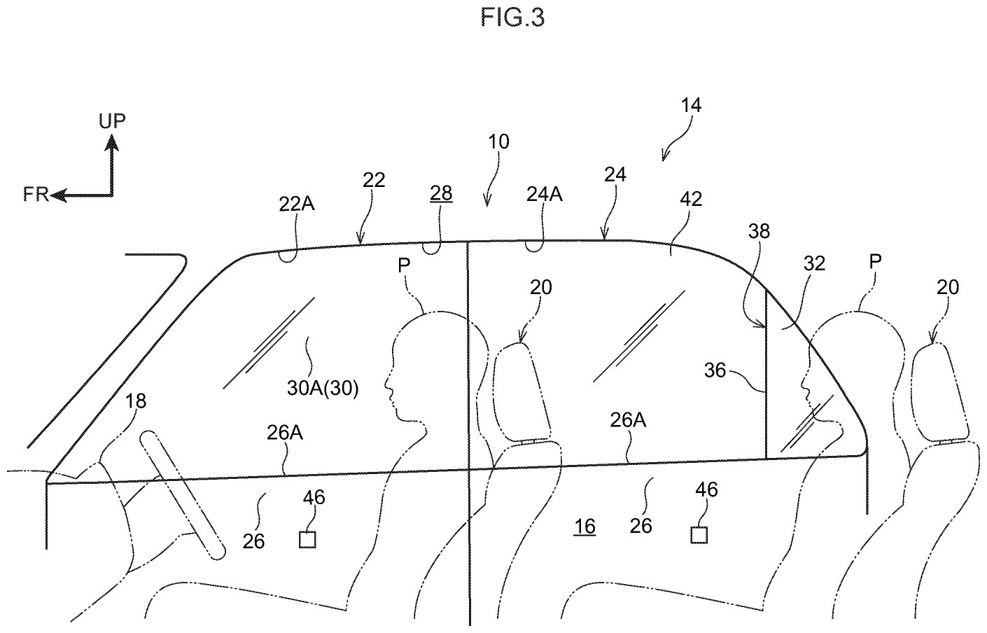

As illustrated in FIG. 3, the vehicle display device 10 is installed in a vehicle 14 that is capable of being autonomously driven by an autonomous driving control device 12 (see FIG. 1). An instrument panel 18 is provided at the vehicle front side in a cabin 16 of the vehicle 14. Specifically, the instrument panel 18 is disposed at an upper side of a vehicle rear side of a dash panel (not illustrated in the drawings) partitioning the cabin 16 from a vehicle front section.

Vehicle seats 20 are provided at the vehicle rear side of the instrument panel 18. Specifically, front vehicle seats 20 are disposed toward the vehicle front side of the cabin 16, and rear vehicle seats 20 are disposed toward the vehicle rear side of the cabin 16.

The autonomous driving control device 12 performs autonomous driving control to cause the vehicle 14 to travel autonomously, by determining circumstances of the vehicle 14 and its surroundings based on route information in a map information storage section in which information obtained through a navigation system (none of which are illustrated) is stored, and information obtained from various non-illustrated sensors, and controlling acceleration amounts, braking amounts, steering angles and so on until reaching a destination. Namely, the autonomous driving control device 12 performs autonomous driving of the vehicle 14. Note that the driving control performed by the autonomous driving control device 12 during autonomous driving is, for example, that known from JP-A No. 2008-123197, and so detailed explanation thereof is omitted.

A pair of left and right front doors 22 and a pair of left and right rear doors 24 are provided at the vehicle width direction outer sides of the cabin 16. Each of the front doors 22 and the rear doors 24 is configured including a front door frame 22A or a rear door frame 24A, serving as a door frame configuring the front door 22 or the rear door 24, and a door trim 26 provided as an interior member at the cabin inside of the front door 22 or the rear door 24. An opening 28 opening along a substantially vehicle width direction is provided between a vehicle upper end portion 26A of each of the door trims 26 and the corresponding front door frame 22A or rear door frame 24A. Side window glass 30 is provided in the opening 28.

Locations of the side window glass 30 excluding a triangular window section 32, serving as a separate section described below (these locations are hereafter collectively referred to as a side window glass main section 30A), are capable of being moved along the substantially vehicle vertical direction within the front door 22 or the rear door 24 by non-illustrated raising/lowering mechanisms. The triangular window section 32 is provided at a position corresponding to a rear end portion of the side window glass 30 and to the corresponding rear vehicle seat 20. The triangular window section 32 is fitted into a fixed window frame 38 configured by the rear door frame 24A of the corresponding rear door 24 and a divider bar 36 extending in the substantially vehicle vertical direction within the opening 28, and is configured so as to be immovable along the substantially vehicle vertical direction. Namely, the triangular window section 32 corresponds to a triangular window provided in a typical vehicle. Note that the side window glass 30 has a laminated structure configured by layering plural sheets of non-illustrated transparent glass.

Hardware Configuration

FIG. 1 is a block diagram illustrating a hardware configuration of the vehicle display device 10. The vehicle display device 10 is connected to a bus 40. Plural on-board devices used to perform different control of the autonomous driving control device 12, a non-illustrated car navigation system, various on-board multimedia devices or the like capable of outputting audio data, and so on are connected to the bus 40.

The vehicle display device 10 is provided with transparent displays 42, serving as a display section, a display control device 44, serving as a switching section, and operation switches 46, serving as an operation section. These respective configurations are connected together through a bus 41 so as to be capable of communicating with each other. As an example, the transparent displays 42 are provided as a left and right pair at the vehicle width direction outer sides of the cabin 16 (see FIG. 3). Note that the following explanation focuses on the transparent display 42 on one vehicle width direction side.

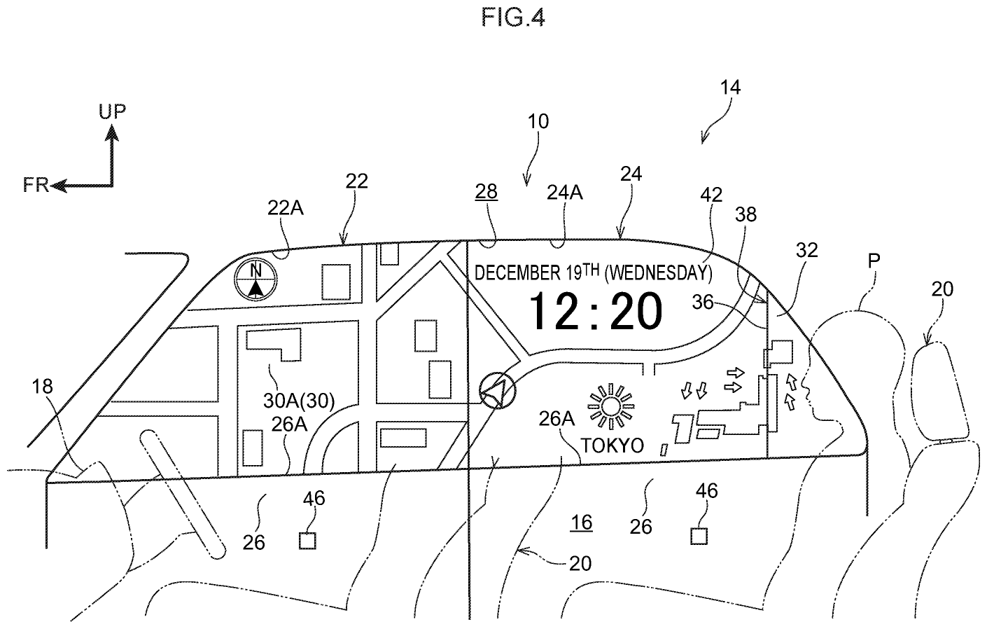

Each of the transparent displays 42 is provided spanning substantially the entire side window glass 30, including the triangular window section 32. Specifically, the transparent display 42 is, as an example, formed in a sheet shape, and is provided superimposed on the glass configuring the side window glass 30. The transparent display 42 is configured by a member with similar transparency to the glass of the side window glass 30, and therefore allows light to pass through. The transparent display 42 is also capable of displaying imagery when applied with a current (see FIG. 4). Namely, in a state in which imagery is not being displayed on the transparent display 42, occupants P are able to perceive the scenery outside the vehicle through the side window glass 30. In a state in which imagery is being displayed on the transparent display 42, the occupants P are unable to perceive the scenery outside the vehicle through the side window glass 30, or the scenery is difficult to perceive. Note that the transparent display 42 where provided to the triangular window section 32 is physically separated from the transparent display 42 where provided to the side window glass main section 30A by the divider bar 36 (see FIG. 3).

The display control device 44 is configured including an internal Central Processing Unit (CPU) 50, Read Only Memory (ROM) 52, Random Access Memory (RAM) 54, and storage 56. The respective configurations are connected together through a non-illustrated bus so as to be capable of communicating with each other.

The CPU 50 is a central processing unit that executes various programs and controls the various sections. Namely, the CPU 50 reads a program from the ROM 52 or the storage 56, and executes the program using the RAM 54 as a workspace. The CPU 50 controls the respective configurations and performs various computation processing according to the program stored in the ROM 52 or the storage 56. In the present exemplary embodiment, the stored program is a display control program to perform processing for imagery display on the transparent display 42 during autonomous driving of the vehicle 14.

One of the operation switches 46 is provided for each of the plural vehicle seats 20. As an example, the operation switches 46 are provided in the door trims 26 close to the respective vehicle seats 20 (see FIG. 3). In other words, the operation switches 46 are provided at positions allowing operation by occupants sitting in the vehicle seats 20. The corresponding operation switch 46 can operated so as to select a display state in which imagery is displayed on the transparent display 42 at the triangular window section 32, or a non-display state in which imagery is not displayed on the transparent display 42 at the triangular window section 32.

Functional Configuration

When the above-mentioned display control program is executed, the vehicle display device 10 implements various functionality employing the above hardware resources. Explanation follows regarding functional configurations implemented by the vehicle display device 10.

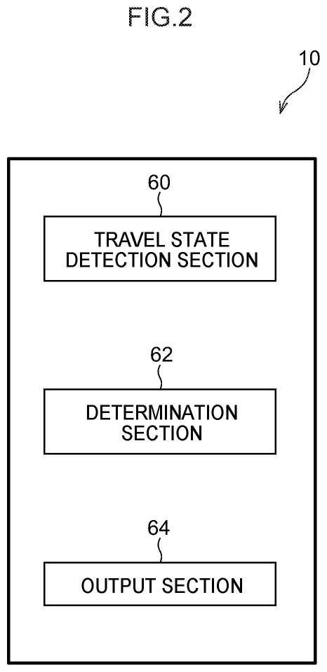

FIG. 2 is a block diagram illustrating an example of functional configurations of the display control device 44 of the vehicle display device 10. The display control device 44 includes a travel state detection section 60, a determination section 62, and an output section 64 as functional configurations. Each functional configuration is implemented by the CPU 50 of the display control device 44 reading and executing the display control program stored in the ROM 52 or the storage 56 (see FIG. 1).

The travel state detection section 60 receives information relating to an operational status of the autonomous driving control device 12, and determines whether or not autonomous driving of the vehicle 14 is in progress.

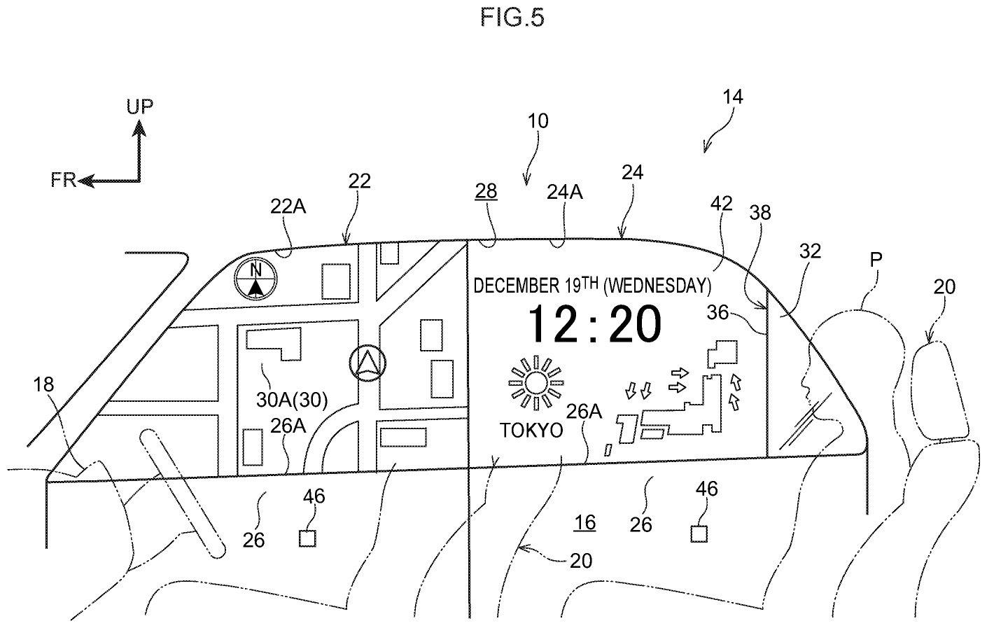

The determination section 62 determines whether or not to display imagery on the transparent display 42 according to the travel state of the vehicle 14 and the ON/OFF state of the corresponding operation switch 46. More specifically, in cases in which autonomous driving of the vehicle is in progress, the determination section 62 displays relevant information, such as map information, the weather at a destination, and the time, according to the travel state and the like on the transparent display 42. The determination section 62 does not display imagery on the transparent display 42 at the triangular window section 32 of the side window glass 30 in cases in which the corresponding operation switch 46 has been switched ON (see FIG. 5). The determination section 62 displays imagery continuous to that on the transparent display 42 at the side window glass main section 30A on the transparent display 42 at the triangular window section 32 of the side window glass 30 in cases in which the corresponding operation switch 46 has been switched OFF (see FIG. 4).

The output section 64 outputs imagery to the transparent display 42 according to the result determined by the determination section 62. In cases in which the output section 64 does not output imagery, the transparent display 42 adopts a state allowing light to pass through (see FIG. 3). In cases in which the output section 64 outputs imagery, the output imagery is output so as to be displayed over substantially the entire transparent display 42 at at least the side window glass main section 30A.

Processing Flow

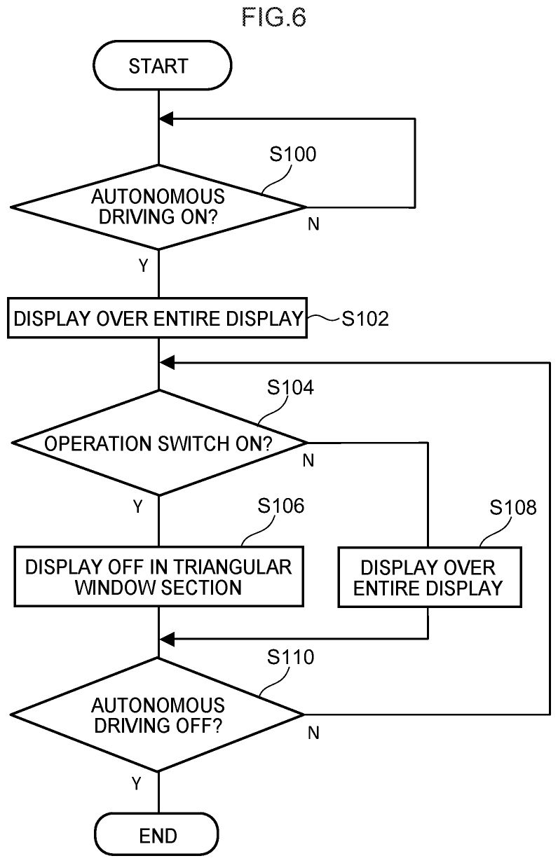

Explanation follows regarding operation of the vehicle display device 10. FIG. 6 is a flowchart illustrating a flow of operation by the vehicle display device 10. The CPU 50 reads the display control program from the ROM 52 or the storage 56, and expands the program into the RAM 54 to be implemented in order to perform display processing.

The CPU 50 determines whether or not autonomous driving of the vehicle 14 is in progress (step S100). In cases in which autonomous driving of the vehicle 14 is not in progress (step S100: NO), the CPU 50 repeats the processing of step S100.

In cases in which autonomous driving of the vehicle 14 is in progress (step S100: YES), the CPU 50 displays imagery over the entire transparent display 42 (step S102). Namely, imagery continuous to the transparent display 42 at the side window glass main section 30A is displayed on the transparent display 42 at the triangular window section 32 of the side window glass 30 (see FIG. 4). The CPU 50 then determines whether or not the corresponding operation switch 46 has been switched ON (step S104). In cases in which the corresponding operation switch 46 is switched OFF (step S104: NO), the CPU 50 continues to display the imagery over the entire transparent display 42 (step S108), and processing transitions to step S110, described below. In cases in which the corresponding operation switch 46 has been switched ON (step S104: YES), the CPU 50 does not display the imagery on the transparent display 42 at the triangular window section 32 of the side window glass 30 (see FIG. 5) (step S106).

The CPU 50 then determines whether or not autonomous driving of the vehicle 14 has ended (step S110). In cases in which autonomous driving of the vehicle 14 has not ended (step S110: NO), the CPU 50 repeats the processing from step S104. In cases in which autonomous driving of the vehicle 14 has ended (step S110: YES), the CPU 50 ends the processing based on the display control program.

Operation and Effects

Explanation follows regarding operation and effects of the present exemplary embodiment.

As illustrated in FIG. 4, in the present exemplary embodiment the transparent display 42 of the vehicle display device 10 is provided to the side window glass 30 of the vehicle 14, and enables imagery to be displayed over substantially the entire side window glass 30. Since the transparent display 42 also has light-transmitting properties, the situation outside the vehicle can be checked from inside the cabin 16 when imagery is not being displayed, as illustrated in FIG. 3. The transparent display 42 is also provided at the triangular window section 32 at a position corresponding to the rear vehicle seat 20, and the triangular window section 32 can be switched between a display state and a non-display state of imagery using the display control device 44. Namely, an occupant P sitting in the corresponding vehicle seat 20 is able to easily check the situation outside the vehicle by setting the triangular window section 32 to the imagery non-display state. Moreover, by switching between the display state and the non-display state of imagery at the triangular window section 32 alone, the display state of imagery at the side window glass main section 30A can be maintained, such that of plural occupants P, any occupants other than the occupant P who wants to check the situation outside the vehicle are able to perceive the imagery on the side window glass main section 30A of the transparent display 42. This enables a comfortable in-cabin space appropriate to the circumstances to be provided.

The fixed window frame 38 with the triangular window section 32 provided therein is configured by the divider bar 36 and the rear door frame 24A. Namely, a fixed window configured by the fixed window frame 38 is provided to a typical side window glass 30, with the fixed window being separated from the side window glass main section 30A by the divider bar 36. Accordingly, the separation between the triangular window section 32 and the side window glass main section 30A of the transparent display 42 can be performed using an existing member. This enables a reduction in costs.

The display control device 44 is capable of being switched between displaying and not displaying imagery on the triangular window section 32, in response to operation of the corresponding operation switch 46. The operation switch 46 is operable by at least the occupant P sitting in the rear vehicle seat 20 corresponding to the triangular window section 32. Accordingly, the occupant P is able to easily check the situation outside the vehicle or enjoy the imagery on the transparent display 42 by operating the operation switch 46. This enables a comfortable in-cabin space to be provided that better reflects the wishes of the occupant P.

Although the triangular window section 32 is provided at the vehicle rear side of the side window glass 30 in the present exemplary embodiment, there is no limitation thereto, and the triangular window section 32 may be provided at the vehicle front side of the side window glass 30. In such cases, a front seat occupant P who has spun the front rear vehicle seat 20 round so as to face the rear vehicle seat 20 during autonomous driving is able to easily check the situation outside the vehicle through the triangular window section 32 provided at the vehicle front side of the side window glass 30.

The transparent display 42 provided to the side window glass main section 30A is capable of displaying imagery over substantially the entire side window glass main section 30A. However, there is no limitation thereto, and configuration may be made in which the transparent display 42 is capable of displaying imagery over only a portion of the side window glass main section 30A.

The triangular window section 32 is separated from the side window glass main section 30A by the divider bar 36. However, there is no limitation thereto, and the triangular window section 32 may be separated from the side window glass main section 30A by another member.

Moreover, the display control device 44 is configured to switch between displaying and not displaying imagery on the triangular window section 32 according to operation of the corresponding operation switch 46. However, there is no limitation thereto, and configuration may be made such that a non-illustrated in-cabin imaging device or the like detects the behavior of the occupant P and switches between displaying and not displaying imagery according to the behavior of the occupant P, or configuration may be made such that a monitoring device monitors circumstances outside the vehicle and switches between displaying and not displaying imagery according to the situation outside the vehicle.

The present disclosure is not limited to the exemplary embodiment described above, and obviously various other modifications to the above exemplary embodiment may be implemented within a range not departing from the spirit of the present disclosure.

What is claimed is:

1. A vehicle display device comprising:
a display section that is provided at a side window glass of a vehicle, that has light-transmitting properties, and that enables display of imagery over substantially the entire side window glass;
a separate section that is provided at the display section at a position corresponding to a vehicle seat; and
a switching section configured to switch between a display state and a non-display state of imagery on the separate section.

2. The vehicle display device of claim 1, wherein:
the side window glass is provided with a fixed window frame formed by a divider bar extending substantially in a vehicle vertical direction and by a door frame demarcating the side window glass at an upper portion of a vehicle door; and
the separate section is provided within the fixed window frame.

3. The vehicle display device of claim 1, wherein the switching section is configured to switch between the display state and the non-display state of imagery on the separate section, in response to operation of an operation section by an occupant sitting in the vehicle seat corresponding to the separate section.

4. The vehicle display device of claim 1, wherein the separate section is a triangular window section provided at a position corresponding to a rear end portion of the side window glass and to a rear vehicle seat.

5. The vehicle display device of claim 3, wherein one operation section is provided for each of a plurality of vehicle seats.

6. The vehicle display device of claim 3, wherein the switching section includes:
a travel state detection section configured to determine whether or not autonomous driving of the vehicle is in progress;
a determination section configured to determine whether or not to display imagery on the separate section according to a travel state of the vehicle and operation of the operation section; and
an output section configured to output imagery to the separate section according to a result determined by the determination section.
